(19) United States
(12) Patent Application Publication
(10) Pub. No.: US 2025/0370568 A1
(43) Pub. Date: Dec. 4, 2025

(54) OPTIMIZATION METHOD FOR MANUFACTURING SETUP PROCESS OF DUAL-SCREEN DEVICE

(71) Applicant: Silicon Integrated Systems Corp., Hsinchu (TW)

(72) Inventors: Ching hsin HSU, Hsinchu (TW); Ying-hu YEH, Hsinchu (TW); Chao-pang WANG, Hsinchu (TW)

(73) Assignee: Silicon Integrated Systems Corp., Hsinchu (TW)

(21) Appl. No.: 19/192,408

(22) Filed: Apr. 29, 2025

(30) Foreign Application Priority Data
Jun. 3, 2024 (TW) 113120532

(51) Int. Cl. G06F 3/041; G06F 3/04883

(52) U.S. Cl. CPC G06F 3/0418; G06F 3/0412; G06F 3/04883; G06F 2203/04104

(57) ABSTRACT

A method for optimizing a manufacturing setting process of a dual-screen device includes defining a correspondence between a touch gesture and a confirmation signal in a dual-screen device; detecting the touch gesture during a calibration process for a first display of the dual-screen device; determining whether at least one operation gesture on the dual-screen device is the same as the defined touch gesture, and outputting the confirmation signal when the at least one operation gesture on the dual-screen device is the same as the defined touch gesture; and in response to the confirmation signal, continuing to calibrate a second display of the dual-screen device. When screen calibration is performed on a large number of dual-screen devices, there is no need to frequently plug and unplug a keyboard, thereby avoiding cumbersome manufacturing processes and improving production efficiency.

### CROSS REFERENCE TO RELATED APPLICATIONS

This application claims the benefit of priority of Taiwan Patent Application No. 113120532, filed on Jun. 3, 2024, the contents of which are all incorporated by reference as if fully set forth herein in their entirety.

### FIELD OF INVENTION

The present application relates to a method for optimizing a manufacturing setting process, and more particularly to a method for optimizing a manufacturing setting process of a dual-screen device.

### BACKGROUND OF INVENTION

As the computing power of computer devices evolves, computer devices often display and run multiple application programs simultaneously. However, due to the limitation of the displayed range of the screen device, the applications that the user can operate simultaneously are limited. Moreover, for application scenarios that require different screens to display images, a single-screen device cannot meet the needs, so a dual-screen device has its market demand.

In the existing manufacturing process of dual-screen devices (such as point of sale (POS) terminals), the two screens need to be calibrated separately. After completing the calibration (such as touch calibration) of one of the screens, a confirmation signal needs to be input through a keyboard such that the other screen can be calibrated subsequentially. In a mass manufacturing process of dual-screen devices, screen calibration must be completed for each device. The cumbersome operations of plugging and unplugging the keyboard are very inconvenient for the screen calibration work and make the manufacturing process consume too much time, resulting in reduced manufacturing efficiency.

In view of this, it is necessary to provide a method for optimizing the manufacturing setting process of the dual-screen device to solve the above technical problem.

### SUMMARY OF INVENTION

In order to solve the above-mentioned problem of the conventional skill, a purpose of the present application is to provide a method for optimizing the manufacturing setting process of the dual-screen device, which can make the manufacturing setting process of the dual-screen device smoother, avoiding the manufacturing process from being too complicated.

The present application provides a method for optimizing a manufacturing setting process of a dual-screen device, including defining a correspondence between a touch gesture and a confirmation signal in a dual-screen device; detecting the touch gesture during a calibration process for a first display of the dual-screen device; determining whether at least one operation gesture on the dual-screen device is identical to the defined touch gesture, and outputting the confirmation signal when the operation gesture is identical to the defined touch gesture; and continuing to calibrate a second display of the dual-screen device in response to the confirmation signal.

In some embodiments of the present application, the step of determining whether at least one operation gesture on the dual-screen device is identical to the defined touch gesture includes: analyzing a gesture data received from the dual-screen device to determine whether the gesture data matches the touch gesture, outputting the confirmation signal when the gesture data matches the touch gesture.

In some embodiments of the present application, before the step of analyzing the gesture data received from the dual-screen device to determine whether the gesture data matches the touch gesture, the method further includes: enabling a multi-touch sensing function of the dual-screen device; notifying an operating system to start transmitting a multi-touch data; and obtaining the gesture data based on the multi-touch data.

In some embodiments of the present application, the touch gesture is a five-finger gesture.

In some embodiments of the present application, the dual-screen device is a point of sale (POS) terminal.

In some embodiments of the present application, the first display and the second display of the point of sale terminal are a front screen and a back screen of the dual-screen device respectively, one of the first display and the second display is configured to face a payee, and the other of the first display and the second display is configured to face a payer.

In some embodiments of the present application, a screen size and a resolution of the first display and the second display are different from each other.

In some embodiments of the present application, a screen size and a resolution of the first display and the second display are the same.

In some embodiments of the present application, the confirmation signal includes a calibrated screen size, a calibrated resolution or a calibrated screen name of the first display to distinguish whether the first display is a main screen or a secondary screen.

In some embodiments of the present application, the confirmation signal includes an authority parameter, and after calibrating the second display, the method further includes: selectively adjusting operation function permissions of the first display and the second display according to the authority parameter included in the confirmation signal.

Compared with the existing art, the present application provides a method for optimizing the manufacturing setting process of a dual-screen device, which includes defining a correspondence between a touch gesture and a confirmation signal in a dual-screen device, and detecting the touch gesture during a calibration process for a first display of the dual-screen device to whether at least one operation gesture on the dual-screen device is identical to the defined touch gesture, and outputting the confirmation signal when the operation gesture is identical to the defined touch gesture, and continuing to calibrate a second display of the dual-screen device in response to the confirmation signal. In the mass manufacturing process of dual-screen devices, screen calibration no longer needs to rely on an external signal input device (such as a keyboard). The dual-screen device can output the confirmation signal in place of the external signal input device, thereby eliminating tedious operations of plugging and unplugging the input interface during the calibration process. In such a way, overall manufacturing efficiency is improved and the manufacturing process is optimized.

The following is a detailed description of the specific embodiments in conjunction with the attached figures, which will make it easier to understand purposes, technical contents, characteristics and effects achieved by the present application.

### DESCRIPTION OF FIGURES

FIG. 1 is a flow chart of a method for optimizing a manufacturing setting process of a dual-screen device according to one embodiment of the present application.

FIG. 2 is a flow chart of a gesture detection method for a dual-screen device according to one embodiment of the present application.

### DETAILED DESCRIPTION OF PREFERRED EMBODIMENTS

The technical solutions in the embodiments of the present application will be described clearly and completely below in conjunction with the figures in the embodiments of the present application. Obviously, the described embodiments are only part of the embodiments of the present application, rather than all of the embodiments. In addition, it should be understood that the specific embodiments described herein are only used to illustrate and explain the present application, and are not used to limit the present application. Referring to the figures, identical reference numerals represent the same elements.

One embodiment of the present application provides a method for optimizing a manufacturing setting process of a dual-screen device (such as a point of sale (POS) terminal). During a calibration process of the screen, at least one operation gesture of the user on the dual-screen device is detected. A confirmation signal representing the confirmation operation is output when the gesture is the same as a predefined touch gesture. Therefore, there is no need to frequently plug and unplug a keyboard when the calibration is performed for a large number of dual-screen devices, thereby avoiding the problem of an overly complicated manufacturing process. In this way, production efficiency is improved.

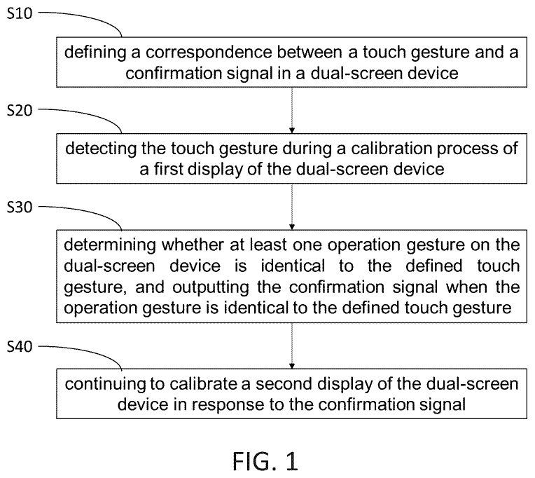

First, please refer to FIG. 1, which is a flow chart of a method for optimizing a manufacturing setting process of a dual-screen device according to one embodiment of the present application. The present application provides a method for optimizing a manufacturing setting process of the dual-screen device, including the following steps:

S10: Defining a correspondence between a touch gesture and a confirmation signal in a dual-screen device.

In the embodiment of the present application, a gesture detection program can be used to detect at least one operation gesture of a user on a dual-screen device (such as a POS terminal). Before this, the gesture detection program may be installed in the dual-screen device, and a correspondence between a touch gesture and a confirmation signal may be predefined in the gesture detection program. Specifically, the touch gesture may trigger or simulate a key signal of a keyboard, such as an Enter signal. Of course, the touch gesture may also trigger or simulate other key signals of the keyboard, not limited to the Enter signal. For example, the gesture detection program may trigger the sending of the Enter signal of the keyboard when the user touches the dual-screen device with five fingers at the same time (i.e., a five-finger gesture). In addition, the confirmation signal may not be a key signal of the keyboard, but may be any signal representing a confirmation operation.

S20: Detecting the touch gesture during a calibration process of a first display of the dual-screen device.

In the embodiment of the present application, the gesture detection program is used in the calibration process of two displays of a dual-screen device. During the screen calibration process, the gesture detection program detects the user's gesture and provides the confirmation signal in the form of gesture detection instead of a physical keyboard. The user can make a predefined touch gesture when the user has completed calibration of the first display. At this time, the gesture detection program detects the predefined touch gesture and sends the confirmation signal to notify the calibration program that the calibration of the first display has been completed.

S30: determining whether at least one operation gesture on the dual-screen device is identical to the defined touch gesture, and outputting the confirmation signal when the operation gesture is identical to the defined touch gesture.

In the embodiment of the present application, during the process of detecting the touch gesture, the gesture detection program can be used to determine whether the detected gesture matches the touch gesture predefined in Step 810. Specifically, the gesture detection program determines whether the operation gesture on the touch receiver (e.g., touch display) on the dual-screen device is the same as the predefined touch gesture. If the two are the same, the gesture detection program outputs the confirmation signal. There are many ways to determine whether the gesture detected from the touch receiver is the same as the predefined touch gesture, which can be referred to in the relevant arts and will not be described in detail herein. In addition, the gesture detection program can output a key value of a certain key of a physical keyboard or a signal of a certain key combination as the output of the confirmation signal. In addition, the confirmation signal output by the gesture detection program may also be any signal representing a confirmation operation in the calibration program.

S40: Continuing to calibrate a second display of the dual-screen device in response to the confirmation signal.

In the embodiment of the present application, it is considered that the user has completed the calibration of the first display when the screen calibration program receives the confirmation signal. At this time, the calibration program can continue to calibrate a second display of the dual-screen device. If the screen calibration program receives the confirmation signal during the calibration process of the second display, the calibration program may consider that the user has completed the calibration of the second display and terminate the entire process or wait for the user to close the calibration program if a next display cannot be found for calibration.

It should be additionally noted that the dual-screen device is configured to include at least one touch receiver, and the dual-screen device detects the operation gesture by activating the multi-touch sensing function of the touch receiver. The touch receiver may be disposed on the first display and/or the second display of the dual-screen device. In this case, the first display and/or the second display is a touch display with a touch function. Therefore, in the process of calibrating the dual-screen device, the input of at least one of the operation gestures does not need to be limited to the input only through the calibrated first display, and before the calibration, the dual-screen device of the present application does not need to identify whether it is a touch display with touch function as a condition for distinguishing the first display from the second display. Therefore, the convenience in calibration and authority allocation flexibility of the manufacturing setting process of the dual-screen device of the present application are improved.

In the manufacturing setting process optimization method of the dual-screen device of the embodiment of the present application, a correspondence between a touch gesture and a confirmation signal is defined in a dual-screen device, and during the calibration process of the first display of the dual-screen device, the touch gesture is detected to determine whether the operating gesture on the dual-screen device is the same as the defined touch gesture. The confirmation signal is output and a second display of the dual-screen device is calibrated subsequentially when the operation gesture on the dual-screen device is the same as the defined touch gesture. In the mass manufacturing process of dual-screen devices, screen calibration no longer needs to rely on an external signal input device (such as a keyboard). The dual-screen device can output the confirmation signal in replace of the external signal input device, thereby eliminating the tedious operations of plugging and unplugging the input interface during the calibration process. In such a way, overall manufacturing efficiency is improved and the manufacturing process is optimized.

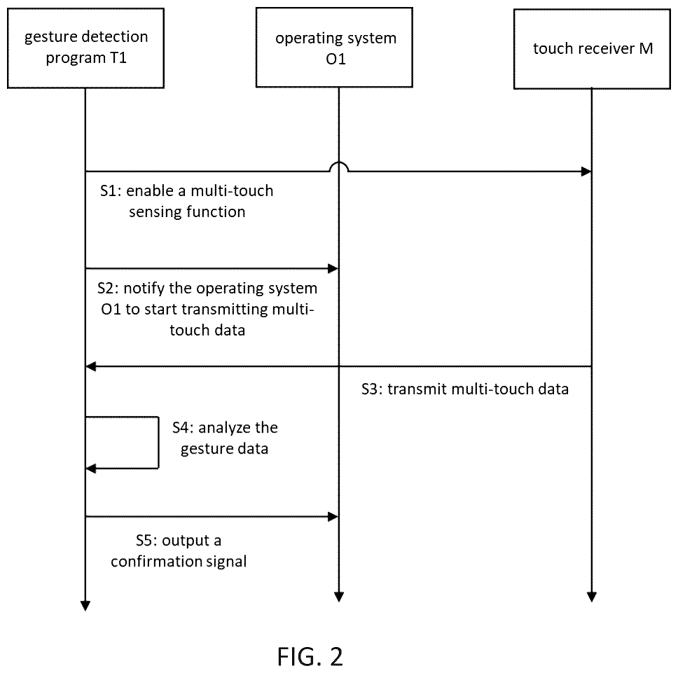

Next, please refer to FIG. 2, which is a flow chart of a gesture detection method for a dual-screen device according to one embodiment of the present application. The gesture detection method of the dual-screen device provided in the present application involves the operations of a gesture detection program T1, an operating system O1, and a touch receiver M.

The following is illustrated with an example of the predefined touch gesture being a five-finger gesture. In Step S1, during the screen calibration process of the dual-screen device through the calibration program, the gesture detection program T1 notifies the touch receiver M to enable the multi-touch sensing function. In Step S2, the gesture detection program notifies the operating system O1 to start transmitting multi-touch data. In Step S3, after the touch receiver M enables multi-touch, the touch receiver M transmits to the gesture detection program T1 the data of the touch points corresponding to a touch event when the touch receiver M detects the touch event. The touch receiver M can be configured to transmit the touch point data (i.e., multi-touch data) to the gesture detection program T1 via the operating system O1 or directly transmit the touch point data to the gesture detection program T1. In Step S4, after receiving the multi-touch data, the gesture detection program T1 obtains gesture data based on the multi-touch data by identifying a pattern formed by the multi-touch data, for example. The gesture detection program T1 then analyzes whether the gesture data matches the touch gesture. In Step S5, the gesture detection program T1 outputs a confirmation signal to the operating system O1 when the gesture detection program T1 determines that the gesture data matches the touch gesture, and then proceeds to calibrate the second display of the dual-screen device.

In one embodiment of the present application, the user must make a gesture that matches the predefined gesture data before the gesture detection program T1 outputs the confirmation signal, thereby preventing the user from accidentally outputting the confirmation signal due to a false touch.

In one embodiment provided in the present application, the dual-screen device is a POS terminal, for example, different types of POS machines used in retail, catering, and service industries, or POS machines that can be used in mobile environments such as exhibitions, markets, food trucks, etc., and that need to display images to both the payer and the payee at the same time.

In one embodiment provided in the present application, the first display and the second display of the sales terminal are a front display and a back display of a dual-screen device respectively, one of the first display and the second display is configured to face the payee, and the other of the first display and the second display is configured to face the payer.

In one embodiment provided in the present application, the screen size and resolution of the first display and the second display in the dual-screen device are different from each other. The manufacturer can decide the configuration of the first display and the second display according to the application scenarios to reduce an overall cost of the dual-screen device.

In one embodiment provided in the present application, the size and resolution of the first display and the second display in the dual-screen device are the same. When the first display and the second display have the same size and resolution, after the gesture detection program T1 outputs the confirmation signal to the operating system O1, the calibration program continues to calibrate the second display of the dual-screen device, and in this way the first display and the second display having the same size and resolution are calibrated.

In one embodiment provided in the present application, the confirmation signal output by the gesture detection program may also include the screen size, resolution, and screen name of the calibrated first display, so as to distinguish whether the first display is a primary screen or a secondary screen according to the confirmation signal. At the same time, when the second display is calibrated, the confirmation signal is received and whether the second display is a primary screen or a secondary screen can also be determined according to the confirmation signal. Thereby, after receiving the confirmation signal, the primary and secondary configurations and specifications of the first display and the second display can be identified. Therefore, the process of calibrating the dual-screen device through the gesture detection program is optimized in a further step to automatically complete the recognition of the primary and secondary screens.

In one embodiment provided in the present application, the touch gesture is a five-finger gesture, so that an operator can output a confirmation instruction more clearly when the calibration is performed for the first display and the second display, thereby reducing the possibility of mistaken calibration.

In one embodiment provided in the present application, the confirmation signal includes an authority parameter, and after calibrating the second display, the method also includes selectively adjusting operation function permissions of the first display and the second display according to the authority parameter included in the confirmation signal. Thereby, even if the first display and the second display have the same size and resolution, the manufacturer receiving the product can have a pre-customized product.

In one embodiment provided in the present application, the touch receiver is disposed on the first display, and the confirmation signal includes a control parameter. After calibrating the second display, the method also includes setting the second display as an extending screen of the first display according to the control parameter included in the confirmation signal. Accordingly, the present application can set the dual-screen device with an extending screen state after the screens are calibrated.

The present application has at least the following beneficial effects. The present application provides a method for optimizing the manufacturing setting process of a dual-screen device. After the calibration of the first display of the dual-screen device is completed, the producer can control the dual-screen device to start the calibration of the second display without an external input device. In the mass production of dual-screen devices, tedious operations of plugging and unplugging an input interface during calibration are avoided, thereby improving overall production efficiency and optimizing the manufacturing process.

It should be noted that the combination of various elements in the present application preferably forms the above-mentioned multiple embodiments, but this should not be interpreted as a limitation of the present application. Instead, various elements in the present application can also have more combinations, and it is not limited to the above-mentioned multiple embodiments.

Specific examples are used herein to illustrate the principles and implementation methods of the present application. The description of the above embodiments is only used to help understand the technical solution and core idea of the present application. Those skilled in the art should understand that they can still modify the technical solutions described in the aforementioned embodiments, or make equivalent substitutions for some of the technical features therein, and these modifications or substitutions do not cause an essence of the corresponding technical solutions to deviate from the scope of the technical solutions of the embodiments of the present application.

What is claimed is:

1. A method for optimizing a manufacturing setting process of a dual-screen device, comprising:
defining a correspondence between a touch gesture and a confirmation signal in a dual-screen device;
detecting the touch gesture during a calibration process for a first display of the dual-screen device;
determining whether at least one operation gesture on the dual-screen device is identical to the defined touch gesture, and outputting the confirmation signal when the operation gesture is identical to the defined touch gesture; and
continuing to calibrate a second display of the dual-screen device in response to the confirmation signal.

2. The method for optimizing the manufacturing setting process of the dual-screen device of claim 1, wherein the step of determining whether at least one operation gesture on the dual-screen device is identical to the defined touch gesture comprises:
analyzing a gesture data received from the dual-screen device to determine whether the gesture data matches the touch gesture; and
outputting the confirmation signal when the gesture data matches the touch gesture.

3. The method for optimizing the manufacturing setting process of the dual-screen device of claim 2, wherein before the step of analyzing the gesture data received from the dual-screen device to determine whether the gesture data matches the touch gesture, the method further comprises:
enabling a multi-touch sensing function of the dual-screen device;
notifying an operating system to start transmitting a multi-touch data; and
obtaining the gesture data based on the multi-touch data.

4. The method for optimizing the manufacturing setting process of the dual-screen device of claim 1, wherein the touch gesture is a five-finger gesture.

5. The method for optimizing the manufacturing setting process of the dual-screen device of claim 1, wherein the dual-screen device is a point of sale (POS) terminal.

6. The method for optimizing the manufacturing setting process of the dual-screen device of claim 5, wherein the first display and the second display of the point of sale terminal are a front screen and a back screen of the dual-screen device respectively, one of the first display and the second display is configured to face a payee, and the other of the first display and the second display is configured to face a payer.

7. The method for optimizing the manufacturing setting process of the dual-screen device of claim 1, wherein a screen size and a resolution of the first display and the second display are different from each other.

8. The method for optimizing the manufacturing setting process of the dual-screen device of claim 1, wherein a screen size and a resolution of the first display and the second display are the same.

9. The method for optimizing the manufacturing setting process of the dual-screen device of claim 1, wherein the confirmation signal comprises a calibrated screen size, a calibrated resolution, or a calibrated screen name of the first display to distinguish whether the first display is a main screen or a secondary screen.

10. The method for optimizing the manufacturing setting process of the dual-screen device of claim 1, wherein the confirmation signal comprises an authority parameter, and after calibrating the second display, the method further comprises:
selectively adjusting operation function permissions of the first display and the second display according to the authority parameter comprised in the confirmation signal.
